(19) United States
(12) Patent Application Publication
(10) Pub. No.: US 2010/0112336 A1
(43) Pub. Date: May 6, 2010

(54) RFID FOR MATERIAL IDENTIFICATION WITH APPLICATIONS IN MANUFACTURING

(75) Inventors: Pei-Chung Wang, Shanghai (CN); Ningjian Huang, Bingham Farms, MI (US); Gulcin H. Sengir, Bloomfield Hills, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/582,428

(22) Filed: Oct. 20, 2009

Related U.S. Application Data
(60) Provisional application No. 61/111,067, filed on Nov. 4, 2008.

(51) Int. Cl. B32B 5/16; B32B 15/04

(52) U.S. Cl. 428/323; 428/457

(57) ABSTRACT

An RFID tag system and method. An RFID tag is encapsulated within a protective material and formed as a ball. The RFID ball is then mixed with a material that is to be deposited on a particular work piece, such as a coating being deposited on a piece of sheet metal. The RFID ball can later be read when the work piece is in the production environment using a suitable RFID reader. In this manner, the RFID ball forms a permanent part of the work piece and is able to be interrogated at any occasion during the assembly of a product.

### CROSS-REFERENCE TO RELATED APPLICATIONS

This application claims the benefit of the filing date of U.S. Provisional Application Ser. No. 61/111,067, titled RFID for Material Identification with Applications in Manufacturing, filed Nov. 4, 2008.

### BACKGROUND OF THE INVENTION

1. Field of the Invention

This invention relates generally to a system and method for attaching a permanent identification to a product with an RFID tag and, more particularly, to a plurality of RFID tags each encapsulated within a protective ball, where the RFID balls can be added to the product through coating where the balls are interspersed within the coating material, or through casting where the RFID balls are inserted into the product using mechanical force, or through molding where the RFID balls are interspersed within the work material itself.

2. Discussion of the Related Art

In a manufacturing environment, raw materials or work pieces are used to produce products. For example, for high volume automotive applications, many materials, such as various types of sheet metal, are formed into desired parts for the vehicles, such as by stamping, pressing, bending, etc. Typically, these work pieces are coated with various materials when they are delivered to the manufacturing facility. For example, sheet metal may be covered with oil during transportation from a steel mill to a stamping plant. After delivery to the plant, the sheet metal is stored for stamping where the oil acts as a protective barrier. Other coatings include paint and zinc for galvanization.

During the manufacturing process, identification of metal types and other information, such as steel grades and coatings, including manners of applying coatings, in an automotive assembly plant sometimes can be a challenging task. Systems and methods to identify steel grade and other things generally may not be available in the production environment. Various methods, such as mechanical testing and chemical analysis that are known to provide this information typically have required a relatively long cycle time to make a positive identification. Therefore, a need exists for a more effective and straightforward technique to identify information about raw materials being used in a manufacturing process, such as the age of the material, thickness of metal pieces, grade of steel, etc.

During the life-cycle of a product, often the product needs to be identified for its age, origin, and more importantly, its authentication. Various methods exist for this problem, such as barcode scan, but it may not be effective enough to prevent faking the information. Therefore, a need exists for a method that enables permanent identification attachment on a product.

### SUMMARY OF THE INVENTION

In accordance with the teachings of the present invention, an RFID tag system and method are disclosed. An RFID tag is encapsulated within a protective material and formed as a ball. The RFID ball is then mixed with a material that is to be deposited on a particular work piece, such as a coating being deposited on a piece of sheet metal. The RFID ball can later be read when the work piece is in the production environment using a suitable RFID reader. In this manner, the RFID ball forms a permanent part of the work piece and is able to be interrogated at any occasion during the assembly of a product.

Additional features of the present invention will become apparent from the following description and appended claims, taken in conjunction with the accompanying drawings.

### BRIEF DESCRIPTION OF THE DRAWINGS

FIG. 1 is a plan view of an RFID tag encapsulated within a ball;

FIG. 2 is an illustration of a bucket including a coating material and a plurality of RFID balls being added to the coating material;

FIG. 3 is an illustration a work piece covered with a coating in which RFID balls are encapsulated therein, where the work piece is moved relative to an RFID reader so that the RFID balls can be interrogated to determine information about the product; and

FIG. 4 is an illustration of a work piece with RFID balls encapsulated therein.

### DETAILED DESCRIPTION OF THE EMBODIMENTS

The following discussion of the embodiments of the invention directed to a process for providing RFID balls as part of a work piece in a manufacturing environment is merely exemplary in nature, and is in no way intended to limit the invention or its applications or uses.

As will be discussed in detail below, the present invention proposes a system and method by which miniature RFID tags are encapsulated as part of a work piece where the RFID tags are encoded with information about the work piece. In the manufacturing environment, the work piece may be converted into a particular manufactured product, such as a vehicle. An RFID reader can interrogate the work piece at any desirable location to glean information about the work piece.

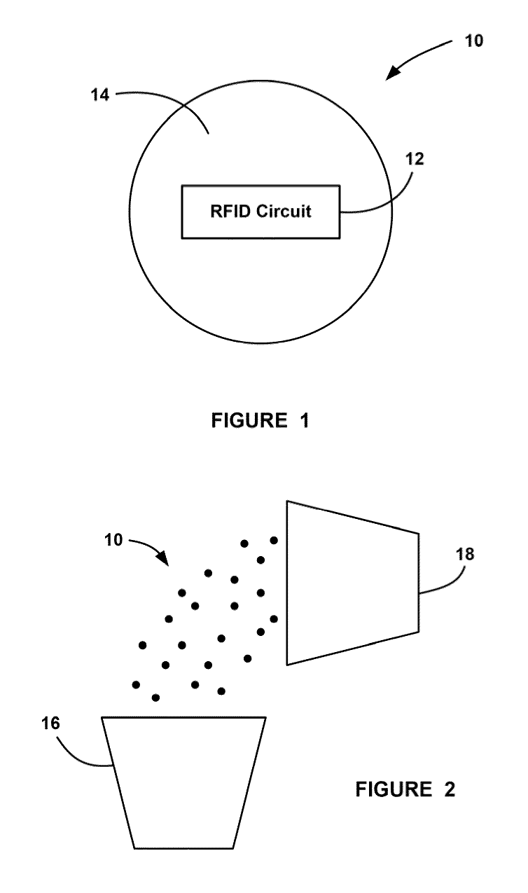

FIG. 1 is an illustration of an RFID ball 10 including an RFID circuit 12. The RFID circuit 12 includes circuit components, such as processors, memories, antennas, etc., in connection with known RFID technology. An RFID reader (discussed below) can interrogate the RFID circuit 12 and wirelessly receive information stored in the circuit 12. The RFID circuit 12 is encapsulated in a protective material 14 formed into the shape of a ball so that the RFID circuit 12 can be provided as part of a product, as will be discussed in further detail below. The protective material 14 can be any material suitable for the purposes described herein, such as a plastic, glass, etc., and can be formed around the RFID circuit 12 in any suitable manner. The RFID balls 10 can have any suitable diameter that can be provided by the existing RFID technology, such as 0.1-1 mm. Although the material 14 is formed in the shape of a ball in this embodiment, other shapes may be equally applicable in other embodiments.

FIG. 2 is an illustration of a bucket 16 including a coating material that is to be coated onto a particular raw material or work piece, discussed below. Another bucket 18 holds many of the RFID balls 10 where the RFID balls 10 are being dumped into the bucket 16 holding the coating material, which will be later deposited on the work piece.

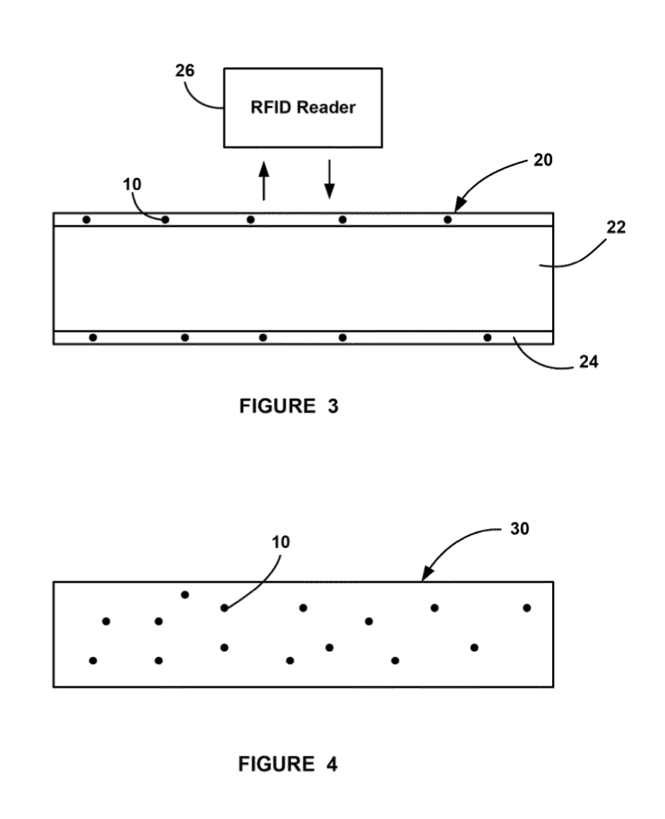

FIG. 3 is a cross-sectional type illustration of a work piece 20 including a main portion 22 and a coating 24. The coating 24 is intended to represent any coating on any work piece that is suitable for the purposes described herein, and is typically a liquid, paste or slurry deposited on the main portion 22 of the work piece 20 in some suitable manner, such as by brushing. Examples of suitable coatings include, but are not limited to, paint, oil, galvanization material, varnishes, protective seals, plastic layers, etc. According to one embodiment, a plurality of the RFID balls 10 are mixed with the coating 24 prior to the coating 24 being formed on the work piece 20. Therefore, several of the RFID balls 10 will be interspersed in the coating 24 on the work piece 20, as shown. Thus, the RFID balls 10 form a permanent part of the work piece 20, and can be interrogated at any desirable time during the manufacturing process. In this example, an RFID reader 26 is shown positioned relative to the work piece 20. As the work piece 20 moves relative to the reader 26, the RFID balls 10 are interrogated to transmit their information. Thus, the RFID balls 10 can be used for part tracking, storage, etc.

In the embodiment discussed above, the RFID balls 10 are interspersed within the coating 24 that is deposited on the main portion 22 of the work piece 20. However, in alternate embodiments, the RFID balls 10 can be embedded in or attached to the work piece 20 by a mechanical process, such as by stamping or pressing. The present invention contemplates any suitable technique for making the RFID balls 10 a permanent part of the work piece 20.

FIG. 4 is an illustration of a work piece 30 including RFID balls 10 interspersed therein. For example, if the work piece 30 is a molded plastic material, the RFID balls 10 can be part of the molded material that is provided to be molded to the shape of the work piece 30 so that after the molding process on the RFID balls 10 are formed as part of the work piece 30 itself. The present invention contemplates any suitable process in which the RFID balls 10 can be formed as part of the work piece 30, where the RFID circuit 12 would be protected by the protective material 14 during the manufacturing process of the work piece 30.

The RFID circuit 12 can be programmed with the information about the work piece 20 in any suitable manner. For example, the RFID balls 10 can be transported down a conveyer system and pass under a programming beam that transmits signals that are received by the RFID circuit 12 to store the information as desired.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A work piece comprising:
a base portion;
a coating formed on the base portion; and
a plurality of RFID devices interspersed in the coating that are a permanent part of the work piece.

2. The work piece according to claim 1 wherein the base portion is a metal sheet and the coating is oil.

3. The work piece according to claim 1 wherein the base portion is a metal sheet and the coating is paint.

4. The work piece according to claim 1 wherein the RFID devices are an RFID circuit encapsulated within a protective material.

5. The work piece according to claim 4 wherein the protective material is shaped as a ball.

6. The work piece according to claim 5 wherein the ball has a diameter in the range of 0.1-1 mm.

7. The work piece according to claim 4 wherein the protective material is plastic.

8. A work piece comprising:
a base portion;
a coating formed on the base portion; and
a plurality of RFID devices interspersed within the coating that form a permanent part of the work piece, wherein the RFID devices include an RFID circuit encapsulated within a protective material where the protective material is shaped as a ball and wherein the RFID circuit stores information about the work piece.

9. The work piece according to claim 8 wherein the base portion is a metal sheet and the coating is oil.

10. The work piece according to claim 8 wherein the base portion is a metal sheet and the coating is paint.

11. The work piece according to claim 8 wherein the protective material is plastic.

12. The work piece according to claim 8 wherein the ball has a diameter in the range of 0.1-1 mm.

13. A work piece comprising a material forming the work piece and a plurality of RFID devices interspersed within the material that are a permanent part of the work piece, where the RFID devices include an RFID circuit encapsulated within a protective material where the RFID circuit stores information about the work piece.

14. The work piece according to claim 13 wherein the protective material is shaped as a ball.

15. The work piece according to claim 14 wherein the ball has a diameter in the range of 0.1-1 mm.

16. The work piece according to claim 13 wherein the protective material is plastic.

17. The work piece according to claim 13 wherein the material is a metal.

18. The work piece according to claim 13 wherein the RFID devices are molded within the work piece.

19. The work piece according to claim 13 wherein the RFID devices are forced within the work piece by a mechanical process.

20. The work piece according to claim 19 wherein the mechanical process is a stamping process.
